(19) United States
(12) Patent Application Publication
(10) Pub. No.: US 2019/0228112 A1
(43) Pub. Date: Jul. 25, 2019

(54) METHOD AND APPARATUS FOR QUALITY RATING-BASED THREE-DIMENSIONAL MODELING OF NUCLEAR POWER PLANT EQUIPMENT

(71) Applicant: KOREA HYDRO & NUCLEAR POWER CO., LTD, Gyeongsangbuk-do (KR)

(72) Inventors: Hye Jin SON, Daejeon (KR); Byeong Suk MOON, Daejeon (KR); Sang Hyun LEE, Daejeon (KR)

(21) Appl. No.: 16/329,366

(22) PCT Filed: Sep. 22, 2016
(86) PCT No.: PCT/KR2016/010558

§ 371 Date: Feb. 28, 2019

(30) Foreign Application Priority Data
Aug. 31, 2016 (KR) 10-2016-0111745

(51) Int. Cl. G06F 17/50

(52) U.S. Cl. CPC G06F 17/50; G21D 1/00; G06F 2217/02

(57) ABSTRACT

Provided is an apparatus for quality rating-based three-dimensional modeling of nuclear power plant equipment. The apparatus performs: receiving, from a design information database, design information of atomic power plant equipment and information on multiple components constituting the atomic power plant equipment; receiving, from a quality rating database, information on the quality rating of each of the multiple components; performing, according to the design information of the nuclear power plant equipment, three-dimensional modeling of at least some of the multiple components constituting the atomic power plant equipment; and displaying the at least some three-dimensionally modeled components among the multiple components, wherein the apparatus may further display information on the quality rating corresponding to each of the multiple components. Therefore, the present invention makes it possible to understand the quality rating-based construction status of a nuclear power plant, and can contribute to an improvement in safety through a quality rating-based alarm.

### TECHNICAL FIELD

The present invention relates to modeling of nuclear power plant equipment, and more particularly, to a method and apparatus for three-dimensional modeling nuclear power plant equipment based on a quality class.

### BACKGROUND ART

A three-dimensional model system was used even in a conventional general construction industry field, and the three-dimensional model system was used for marketing to a general consumer and for grasping a construction progress. In a nuclear power plant construction field, a three-dimensional model system has been recently introduced, and technology of a conventional general construction industry field has been much applied. The construction of a nuclear power plant differs in several aspects from that of a general construction industry field, and in particular, a quality class is given to each equipment of the nuclear power plant and is strictly controlled. Among quality classes, equipment corresponding to particularly a safety class is very important for shortening a construction time and managing a construction quality in nuclear power plant construction, but a quality class is not reflected in the three-dimensional model system.

### DISCLOSURE

### Technical Problem

In order to solve the aforementioned problem, the present invention provides a method of quality class-based three-dimensional modeling of nuclear power plant equipment capable of grasping a main process and improving safety of a nuclear power plant by performing three-dimensional modeling for construction of the nuclear power plant based on a quality class of components of the nuclear power plant equipment.

In order to solve the aforementioned problem, the present invention further provides an apparatus for quality class-based three-dimensional modeling of nuclear power plant equipment capable of grasping a main process and improving safety of a nuclear power plant by performing three-dimensional modeling for construction of the nuclear power plant based on a quality class of components of the nuclear power plant equipment.

Technical objects to be achieved by the present invention are not limited to the foregoing technical objects, but may be variously modified without departing from the spirit and scope of the invention.

### Technical Solution

According to an aspect of the present invention, there is provided a method of quality class-based three-dimensional modeling of nuclear power plant equipment includes receiving design information of the nuclear power plant equipment and information about a plurality of components constituting the nuclear power plant equipment from a design information database; receiving information about a quality class of each of the plurality of components from a quality class database; and three-dimensionally modeling and displaying at least some of a plurality of components constituting the nuclear power plant equipment according to the design information of the nuclear power plant equipment, wherein the three-dimensional modeling and displaying includes further displaying information about a quality class corresponding to each of the plurality of components.

According to an aspect, the method may further include receiving an input of selection of at least one quality class from a user, before the three-dimensional modeling and displaying, wherein the three-dimensional modeling and displaying may include displaying only components having the selected quality class.

According to an aspect, the three-dimensional modeling and displaying may include displaying components having different quality classes with different colors.

According to an aspect, the method may further include receiving an input of selection of a predetermined quality class from a user, after the three-dimensional modeling and displaying; and highlighting a component having the selected quality class.

According to an aspect, the method may further include receiving an input of selection of one of the displayed components, after the three-dimensional modeling and displaying; receiving information about an input/output status and an installation status of the selected component from a construction status database; and displaying process schedule information about the selected component included in the design information of the nuclear power plant equipment and information about the input/output status and the installation status received from the construction status database.

According to one aspect, the quality class may include a class Q (stability related item), a class A (stability impact item), and a class S (general industrial item).

According to an aspect of the present invention, the method may further include receiving information about an installation status of components having a class Q at a predetermined time interval from the construction status database; and transmitting installation status information about any one component to a manager device in response to determination that a process of any one of the components having a class Q has been performed based on the information about the installation status.

According to another aspect of the present invention, there is provided an apparatus for quality class-based three-dimensional modeling of nuclear power plant equipment including a receiver for receiving design information of the nuclear power plant equipment and information about a plurality of components constituting the nuclear power plant equipment from a design information database and information about a quality class of each of the plurality of components from a quality class database; and a modeling unit for three-dimensional modeling at least some of the plurality of components constituting the nuclear power plant equipment according to the design information of the nuclear power plant equipment; and a display unit for displaying at least some of the plurality of three-dimensionally modeled components, wherein the display unit further displays information about a quality class corresponding to each of the plurality of components.

According to an aspect, the apparatus may further include an input unit for receiving an input of selection of one of the components, wherein the receiver may further receive information about an input/output status and an installation status of a selected component from a construction status database, and the display unit may display process schedule information about the selected component included in the design information of the nuclear power plant equipment and information about an input/output status and an installation status received from the construction status database.

According to an aspect, the quality class may include a class Q (stability related item), a class A (stability impact item), and a class S (general industrial item).

According to an aspect, the receiver may receive information about an installation status of components having a class Q at a predetermined time interval from the construction status database, and the quality class-based three-dimensional modeling apparatus for the nuclear power plant equipment may further include a transmitter for transmitting installation status information of any one component to a manager device in response to determination that a process of any one of the components having a class Q has been performed based on the information about the installation status.

According to another aspect of the present invention, there is provided a computer readable storage medium for storing instructions for quality class-based three-dimensional modeling of nuclear power plant equipment, the computer readable storage medium enables a processor of the computer to include an instruction for enabling to receive design information of nuclear power plant equipment and information about a plurality of components constituting the nuclear power plant equipment from a design information database; an instruction for enabling to receive information about a quality class of each of the plurality of components from a quality class database; and an instruction for enabling to three-dimensionally model and display at least some of a plurality of components constituting the nuclear power plant equipment according to design information of the nuclear power plant equipment, wherein the instruction for enabling to three-dimensionally model and display is configured to further display information about a quality class corresponding to each of the plurality of components.

### Advantageous Effects

Disclosed technology can have the following effects. However, because it does not mean that a specific embodiment should include all following effects or should include only the following effects, it should not be understood that the scope of disclosed technology is limited thereto.

According to a method and apparatus for quality class-based three-dimensional modeling of nuclear power plant equipment according to an embodiment of the present invention, a nuclear power plant construction state can be grasped based on a quality class and safety can be improved through alarm based on the quality class.

Further, because an input, output, and installation status of main materials, especially quality management class materials can be grasped on a three-dimensional screen, a visual construction status can be grasped and thus proper period construction can be performed and it is possible to indirectly contribute that a construction period can be shortened through proper period construction stimulation.

### DESCRIPTION OF DRAWINGS

FIG. 1 illustrates a screen for selecting a level and zone for each nuclear power plant building.

FIG. 2 illustrates a screen for selecting on/off according to a quality class of a component.

FIG. 3 illustrates a quality class list of components.

FIG. 4 illustrates a screen for displaying only a specific quality class.

FIG. 5 illustrates construction process management for each quality class.

FIG. 6 is a conceptual diagram illustrating selective opening of a three-dimensional model.

FIG. 7 is a flowchart illustrating a method of quality class-based three-dimensional modeling of nuclear power plant equipment according to a first embodiment of the present invention.

FIG. 8 is a flowchart illustrating a method of quality class-based three-dimensional modeling of nuclear power plant equipment according to a second embodiment of the present invention.

FIG. 9 is a flowchart illustrating a method of quality class-based three-dimensional modeling of nuclear power plant equipment according to a third embodiment of the present invention.

FIG. 10 is a flowchart illustrating an installation status notification process.

FIG. 11 is a block diagram illustrating a configuration of an apparatus for quality class-based three-dimensional modeling of nuclear power plant equipment according to an embodiment of the present invention.

### MODE FOR INVENTION

The present invention may be variously changed and have several embodiments and particular embodiments are described in detail with reference to the drawings.

However, it should be understood that the present invention is not intended to be limited to the particular embodiments, but includes all modifications, equivalents, and alternatives falling within the spirit and scope of the present invention.

A term such as first and second may be used for describing various elements, but the elements are not limited by the terms. The terms are used for distinguishing one element from another element. For example, a first element may be referred to as a second element without deviating from the scope of the present invention, and similarly, a second element may be referred to as a first element. A term “and/or” includes a combination of a plurality of related described items or any element of a plurality of related described items.

When it is described that an element is “connected” or “electrically connected” to another element, the element may be “directly connected” or “directly electrically connected” to the another element or may be “connected” or “electrically connected” to the another element through a third element. However, when it is described that an element is “directly connected” or “directly electrically connected” to another element, no element may exist between the element and the another element.

Terms used in the present application are used for describing a specific embodiment and do not limit the present invention. Unless the context otherwise clearly indicates, words used in the singular include the plural, the plural includes the singular. In the present application, a term “comprise” or “have” indicates presence of a characteristic, numeral, step, operation, element, component, or combination thereof described in a specification and does not exclude presence or addition of at least one other characteristic, numeral, step, operation, element, component, or combination thereof.

Unless differently defined, all terms used here including a technical or scientific term have the same meaning as a meaning that may be generally understood by a person of common skill in the art. It should be analyzed that terms defined in a generally using dictionary have a meaning corresponding with that of a context of related technology and are not analyzed as an ideal or excessively formal meaning unless explicitly defined in the present application.

Hereinafter, an exemplary embodiment of the present invention will be described in detail with reference to the accompanying drawings. In order to facilitate the entire understanding of the present invention, the same reference numerals are used for the same elements in the drawings and redundant explanations for the same elements are omitted.

A quality class of components constituting nuclear power plant equipment is classified into classes Q, A, and S so as to set a quality assurance level applied to a structure, a system, and device.

In relation to a quality class Q (safety related item), a safety related structure, system, and device are classified into a quality class Q according to a relevant regulation, and the Ordinance of the Ministry of Education, Science and Technology (Regulations on Technical Standards for nuclear reactor equipment) and the quality assurance requirements of 10CFR50 annex B are applied to a design, purchase, construction, and operation.

In relation to a quality class A (safety impact items), items or tasks corresponding to the following items other than safety related structures, systems, and devices are classified and managed as a quality class A, and appropriate quality assurance requirements designated for design, purchase, construction, and operation are applied thereto.

A. Items requiring quality assurance in regulatory requirements

B. Hanger or support related to maintenance of structural integrity of earthquake-proof category II class structures and corresponding device

C. Items selected by an operator in consideration of operation experience of nuclear power plants and cases of overseas nuclear power plants and a power generation stop causing device among power conversion and power generation equipment and major equipment related to emergency operation procedures.

In relation to a quality class S (general industrial item), a quality class S is applied to a non-safety related structure, system, and device other than a quality class Q and a quality class A and does not apply quality assurance requirements. The quality class S item is designed, produced, purchased, maintained, and operated according to accepted general industry specifications and standards.

A three-dimensional model system was used even in a conventional general construction industry field, and the three-dimensional model system was used for marketing to a general consumer and for grasping a construction progress. In a nuclear power plant construction field, a three-dimensional model system has been recently introduced, and technology of a conventional general construction industry field has been much applied. However, construction of a nuclear power plant differs in several aspects from that of a general construction industry field, and in particular, as described above, a quality class is given to each equipment of a nuclear power plant and is strictly controlled. Among quality classes, equipment corresponding to particularly a safety class is very important for shortening a construction time and managing a construction quality in nuclear power plant construction, but handling of a quality class is not reflected in a general three-dimensional model system.

According to an embodiment of the present invention, when constructing a nuclear power plant (hereinafter, referred to as a “nuclear power plant”), attribute data (weight, size, and material) of a shape of a three-dimensional model may be searched for according to a quality class (Q, A, S) of nuclear power equipment, a color of a shape of a three-dimensional model according to a quality class may be changed, and an alarm message may be automatically notified to a person in charge or a responsible person before and after a process and thus a major process can be grasped and safety of nuclear power plant construction can be improved.

Further, according to an embodiment of the present invention, while constructing a nuclear power plant, a progress status of each process may be grasped in real time and there is a function of enabling a user to view the corresponding component on a quality class basis and thus a specific device in a specific area of a power plant may be searched for only by a quality class using an ON/OFF function or a component may be grasped on a quality class basis in a specific area. Thereby, when constructing a power plant, a component that should be particularly careful can be grasped and in order to determine whether the component is installed, a material input and output status can be grasped in connection with an installation inspection result DB and a material input and output DB in real time.

In conventional three-dimensional model shape management, only a shape (equipment) itself is shown or only attributes (weight, size, and material) of a shape are represented, but according to an embodiment of the present invention, by providing quality class-based three-dimensional model power plant shape information, a quality of the shape can be grasped and safety can be enhanced. Further, by notifying a terminal of a responsible person or a person in charge through alarm, a construction status can be grasped in real time through a mobile device.

Particularly, in the case of a most important safety quality class Q, a component is displayed with a distinguishable color such as a red color and when a process of the component is performed, by automatically sending alarm to a terminal of a designated person in charge or a responsible person (designated manager), important processes can be grasped.

Further, when the process is completed, by providing alarm, it may be determined whether an important process is completed.

According to an embodiment of the present invention, by forming a power plant building and component into a three-dimensional model and by categorizing a power plant building and component according to a quality class, and when a corresponding quality class is selected, a three-dimensional model is changed to highlight (specific color) and thus an important component can be visually distinguished.

Further, a process status of the component is grasped in connection with a construction process schedule, and in the case of an important quality class, a function notifying a responsible person and a person in charge through alarm is implemented.

When linking with a process schedule, by linking a component installation inspection DB (installation checkable DB/installation inspection report) and material information about the process ACTIVITY (device), a material input/output and installation status can be grasped and all device components can be searched for and inquired based on a quality class.

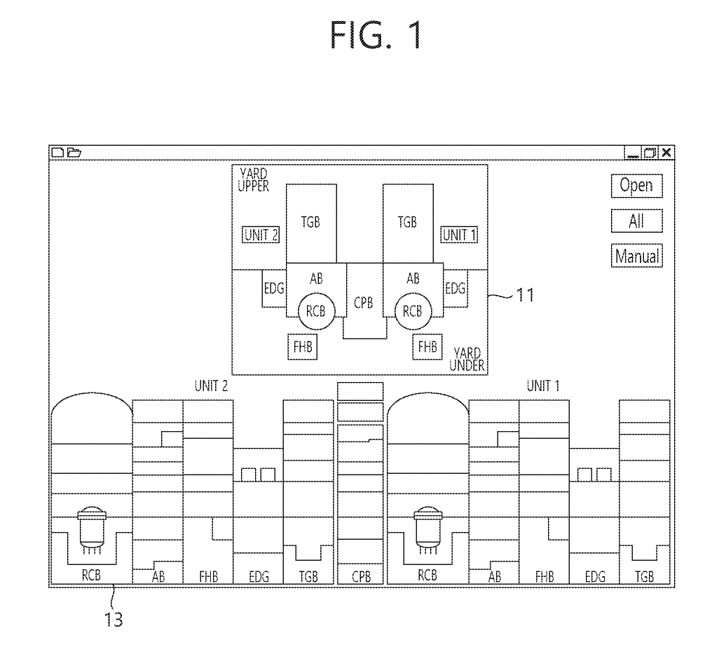

FIG. 1 illustrates a screen for selecting levels and zones for each nuclear power plant building. As illustrated in FIG. 1, according to an embodiment of the present invention, in construction of a nuclear power plant, by displaying a plan view 11 of buildings constituting the nuclear power plant, a user may select a specific building, and by displaying a side view 13 representing a level of buildings, the user may select a level (height, pit) of the building to enable the user to select a desired building and level.

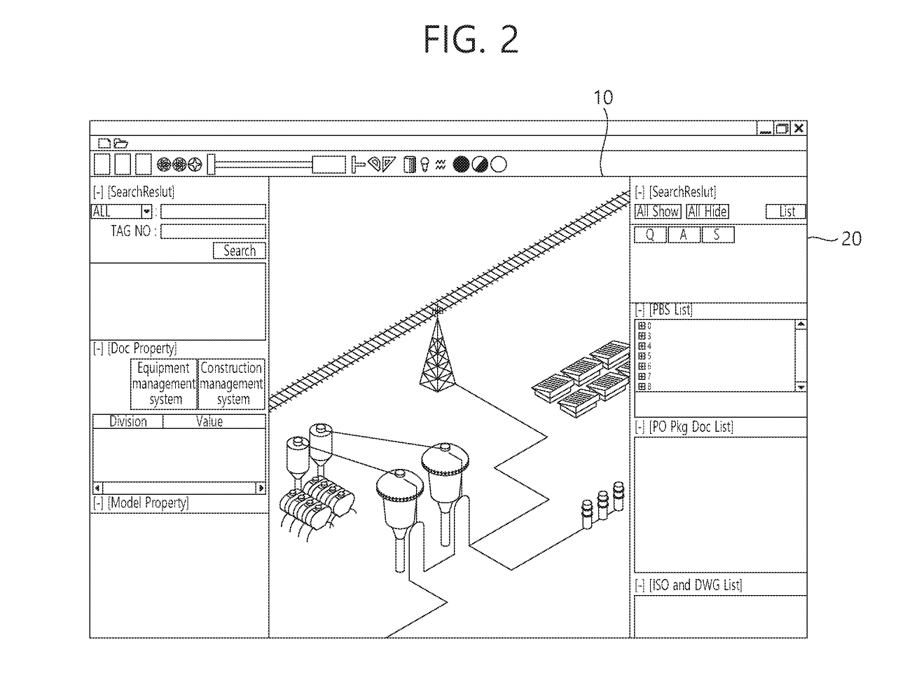

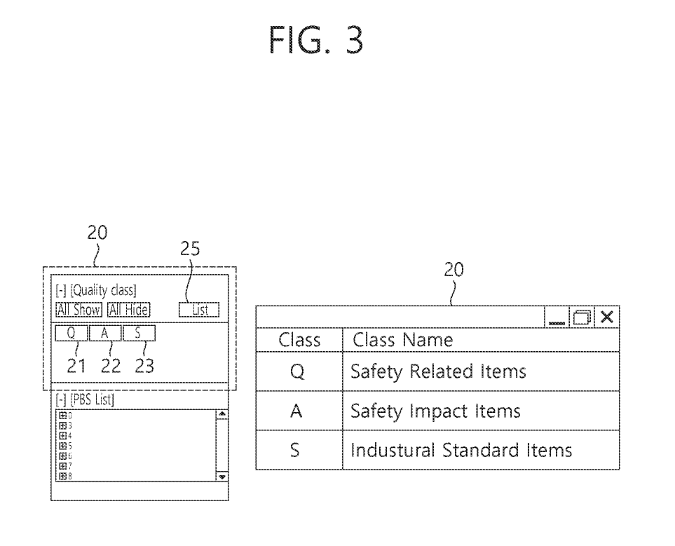

FIG. 2 illustrates a screen for selecting on/off according to a quality class of a component. When a user selects a desired region of a nuclear power plant, such as a predetermined building or level, a three-dimensional modeling result of the region may be displayed in a display area 10. Here, a quality class selection area 20 may be located, for example, at the right side of the display area 10. FIG. 3 illustrates a quality class list of components. As described above, each of components constituting equipment of the nuclear power plant may be classified into classes Q, A, and S and thus the quality class selection area 20 may include a class Q selection button 21, a class A selection button 22, and a class S selection button 23. A list display button 25 may be included in the quality selection area 20, and when the list display button 25 is clicked, a quality class list 27 may be displayed on the screen.

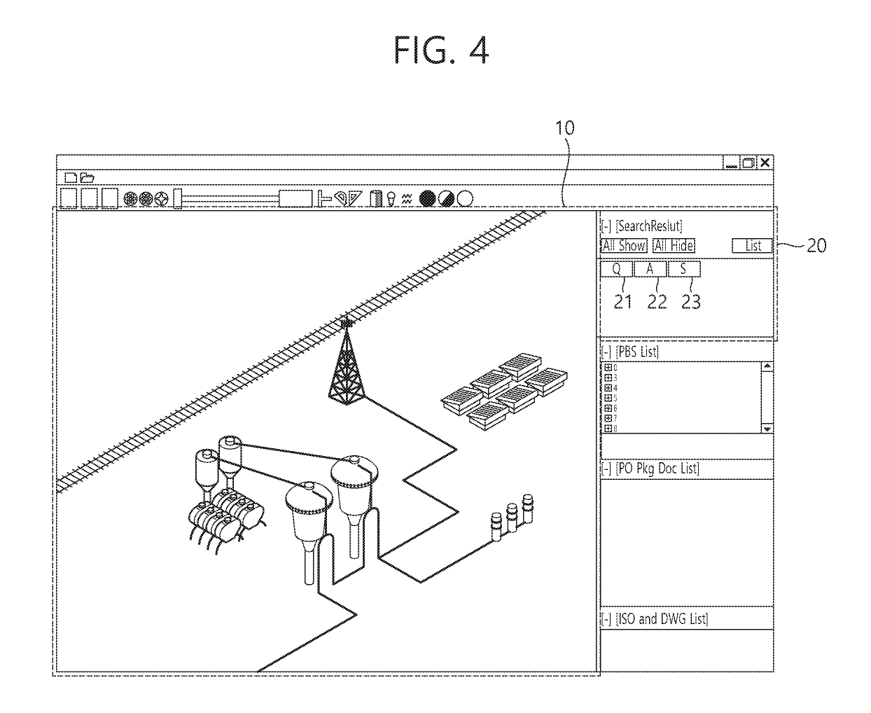

FIG. 4 illustrates a screen for displaying only a specific quality class. As illustrated in FIG. 4, according to an embodiment of the present invention, only a component corresponding to a specific quality class selected by the user may be displayed in the display area 10. Specifically, for example, as illustrated in FIG. 4, when the user clicks and activates the class A selection button 22 in order to display a class A component, only components having a class A may be displayed in the display area 10.

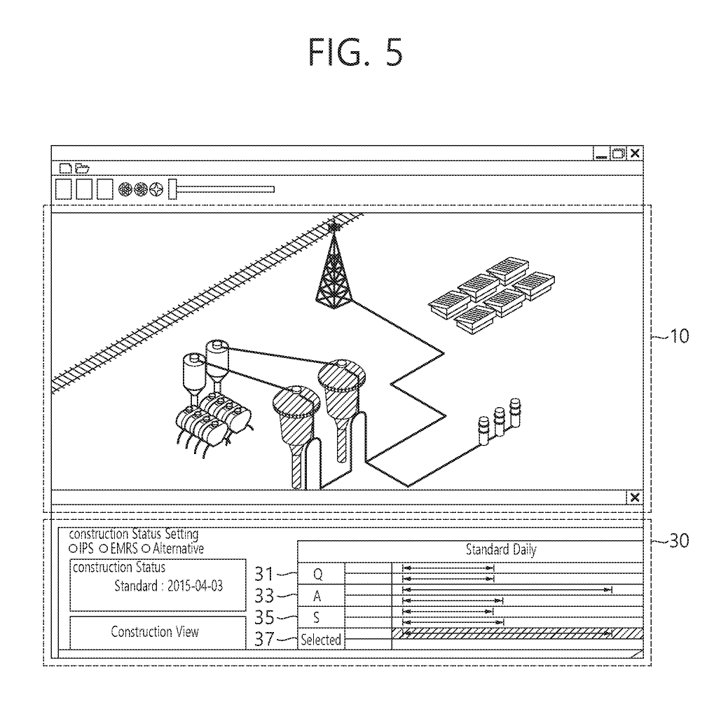

FIG. 5 illustrates construction process management for each quality class. As illustrated in FIG. 5, according to an embodiment of the present invention, when three-dimensional modeling results of each component constituting a nuclear power plant are displayed in the display area 10, the results may be set to have different colors on a quality class basis. As illustrated in FIG. 5, the class Q may be displayed in gray, the class A may be displayed in green, and the class S may be displayed in blue. Accordingly, the user may intuitively recognize a quality class of the component with only a color of the components displayed in the display area 10.

According to an embodiment of the present invention, the user may select at least one of a plurality of components, and the selected components may be highlighted in a color that is noticeable, for example, red.

As illustrated in FIG. 5, according to an embodiment of the present invention, a construction process progress status of components having each quality class and components selected by the user through a construction process progress status display area 30 may be displayed so that a user may grasp it in real time. That is, in the construction process progress status display area 30, a process progress status 31 of a class Q component, a process progress status 33 of a class A component, a process progress status 37 of a class S component, and a process progress status 37 of a component selected by the user may be displayed.

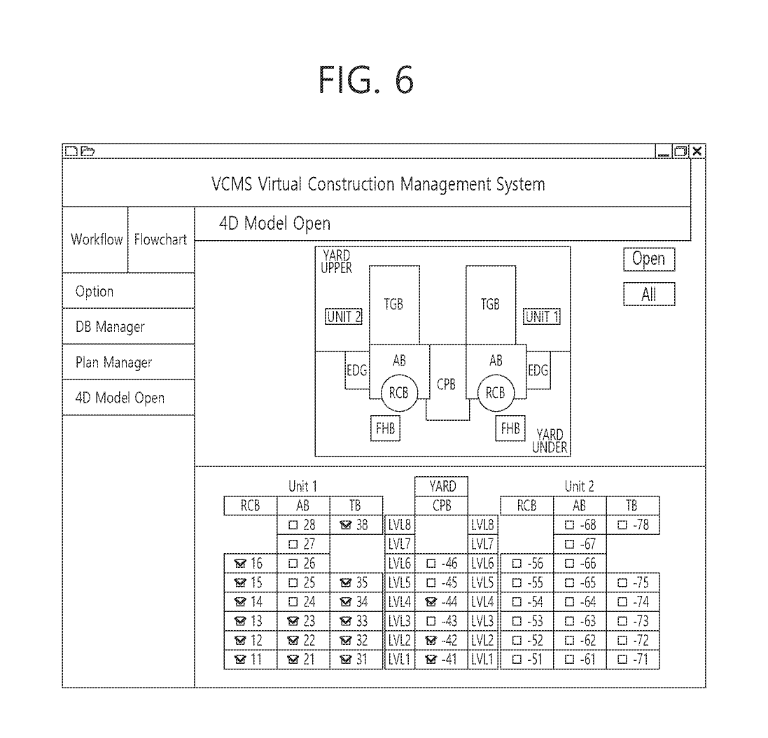

FIG. 6 is a conceptual diagram illustrating selective opening of a three-dimensional model. As illustrated in FIG. 6, the user may select a specific building among buildings constituting a nuclear power plant and select a specific level in the building. Furthermore, as described above, a selection tool of a specific quality class may be added to selectively open a three-dimensional modeling result of a component of the selected quality class.

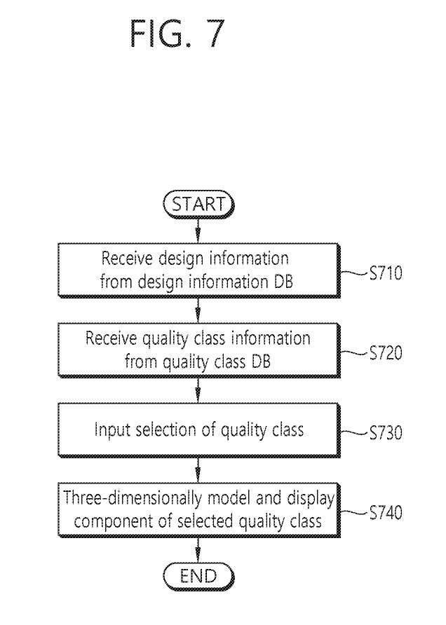

FIG. 7 is a flowchart illustrating a method of quality class-based three-dimensional modeling of nuclear power plant equipment according to a first embodiment of the present invention. Hereinafter, a method of quality class-based three-dimensional modeling of nuclear power plant equipment according to an embodiment of the present invention will be described in detail with reference to FIG. 7.

As illustrated in FIG. 7, in a method of quality class-based three-dimensional modeling of nuclear power plant equipment according to an embodiment of the present invention, design information of nuclear power plant equipment and information of a plurality of components constituting the nuclear power plant equipment may be received from a design information database (step 710). Thereafter, information about a quality class of each of the plurality of components may be received from a quality class database (step 720). Here, selection of at least one quality class may be input by the user (step 730) and then at least some of the plurality of components constituting the nuclear power plant equipment may be three-dimensionally modeled and displayed according to design information of the nuclear power plant equipment (step 740). In three-dimensional modeling and displaying of at least some of the plurality of components, information about a quality class corresponding to each of the plurality of components may be further displayed, and according to one aspect, only components having a quality class selected by the user may be displayed. Therefore, as illustrated with reference to FIG. 4, for example, when a class A is selected, a three-dimensional modeling result of components having a class A may be displayed in the display area 10.

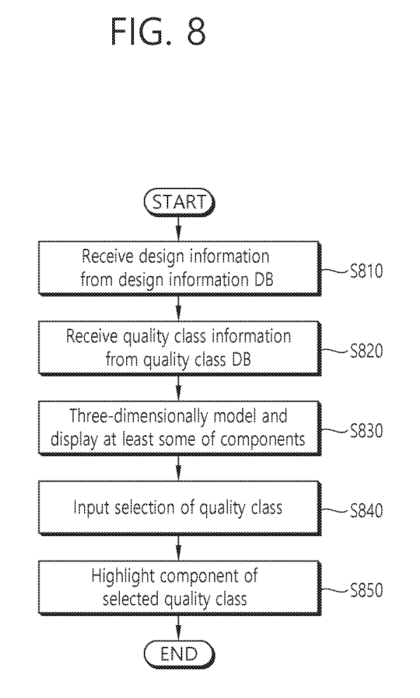

FIG. 8 is a flowchart illustrating a method of quality class-based three-dimensional modeling of nuclear power plant equipment according to a second embodiment of the present invention. Hereinafter, a method of quality class-based three-dimensional modeling of nuclear power plant equipment according to an embodiment of the present invention will be described in detail with reference to FIG. 8.

As illustrated in FIG. 8, in a method of quality class-based three-dimensional modeling of nuclear power plant equipment according to an embodiment of the present invention, design information of nuclear power plant equipment and information of a plurality of components constituting the nuclear power plant equipment may be received from a design information database (step 810). Thereafter, information about a quality class of each of the plurality of components may be received from a quality class database (step 820). Thereafter, at least some of a plurality of components constituting the nuclear power plant equipment may be three-dimensionally modeled and displayed according to design information of the nuclear power plant equipment (step 830). In three-dimensional modeling and displaying at least some of the plurality of components, information about a quality class corresponding to each of the plurality of components may be further displayed. According to an aspect, components having different quality classes may be displayed with different colors, and a unique color may be displayed according to each quality class, as illustrated in FIG. 5.

Selection of a predetermined quality class may be input by the user (step 840), and a component having the selected quality class may be highlighted (step 850). Here, for example, a quality class selected with a color having high visibility such as red may be highlighted.

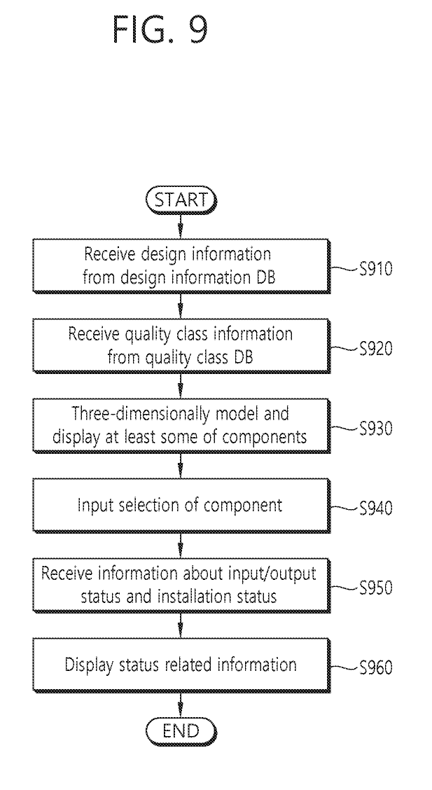

FIG. 9 is a flowchart illustrating a method of quality class-based three-dimensional modeling of nuclear power plant equipment according to a third embodiment of the present invention. Hereinafter, a method of quality class-based three-dimensional modeling of nuclear power plant equipment according to an embodiment of the present invention will be described in detail with reference to FIG. 9.

As illustrated in FIG. 9, in a method of quality class-based three-dimensional modeling of nuclear power plant equipment according to an embodiment of the present invention, design information of nuclear power plant equipment and information about a plurality of components constituting the nuclear power plant equipment may be received from a design information database (step 910). Thereafter, information about a quality class of each of the plurality of components may be received from a quality class database (step 920). Thereafter, at least some of a plurality of components constituting the nuclear power plant equipment may be three-dimensionally modeled and displayed according to design information of the nuclear power plant equipment (step 930). In three-dimensionally modeling and displaying at least some of the plurality of components, information about a quality class corresponding to each of the plurality of components may be further displayed. Selection of one of the displayed components may be input (step 940), and information about an input/output status and an installation status of the selected component may be received from a construction status database (step 950). Thereafter, process schedule information about the selected component included in design information of the nuclear power plant equipment and information about an input/output status and an installation status received from the construction status database may be displayed (step 960) and thus a manager can easily grasp an input/output status and an installation status of selected components among components included in the nuclear power plant equipment.

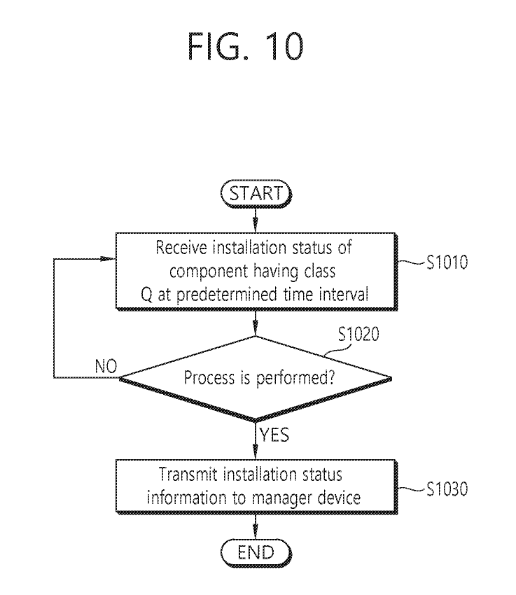

FIG. 10 is a flowchart illustrating an installation status notification process. As illustrated in FIG. 10, according to a method of quality class-based three-dimensional modeling of nuclear power plant equipment according to an embodiment of the present invention, for a predetermined class of components, information related to whether a process is progressed may be automatically notified to a manager device. A quality class of components of nuclear power plant equipment may include a class Q (stability related items), a class A (stability impact item), and a class S (general industrial item), for example, in the case of the stability related items, because it is necessary to manage more thoroughly quality management and an installation status, information notification about an installation status may be transmitted for a component of a class Q.

Specifically, information about an installation status of components having a class Q may be periodically received from the construction status database at a predetermined time interval (step 1010), and it may be determined whether a process of any one of components having a class Q has been performed based on the received information (step 1020). In response to determination that a process of the component has been performed, for example, when a process of the component has been started or when a process of the component has been completed, or when a predetermined process rate has exceeded, installation status information about the any one component may be transmitted to a manager device (step 1030).

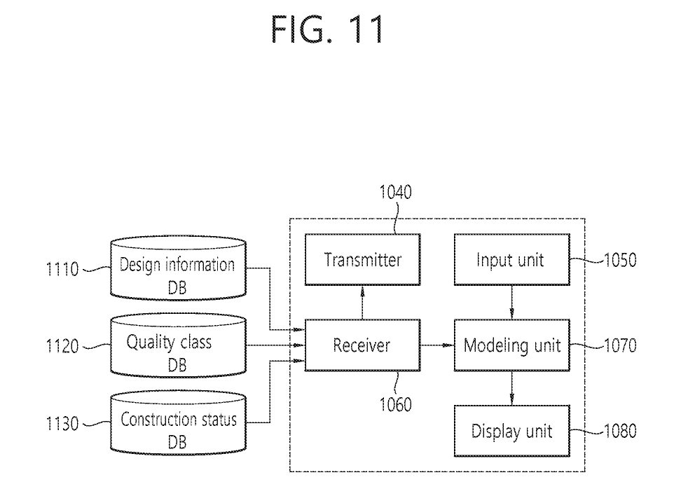

FIG. 11 is a block diagram illustrating a configuration of an apparatus for quality class-based three-dimensional modeling of nuclear power plant equipment according to an embodiment of the present invention. As illustrated in FIG. 11, the apparatus for quality class-based three-dimensional modeling of nuclear power plant equipment according to an embodiment of the present invention may include a transmitter 1040, an input unit 1050, a receiver 1060, a modeling unit 1070, and a display unit 1080.

The receiver 1060 may receive design information about nuclear power plant equipment and information about a plurality of components constituting the nuclear power plant equipment from a design information database 1110 and receive information about a quality class of each of the plurality of components from a quality class database 1130. The modeling unit 1070 may three-dimensionally model at least some of a plurality of components constituting the nuclear power plant equipment according to design information of the nuclear power plant equipment based on the received information. The display unit 1080 may display at least some of the plurality of three-dimensionally modeled components and further display information about a quality class corresponding to each of the plurality of components.

The quality class-based three-dimensional modeling apparatus for the nuclear power plant equipment may further include an input unit 1050 for receiving an input of selection of one of the displayed components, and in this case, the receiver 1060 may further receive information about an input/output state and an installation state of the selected component from the construction status database 1130, and the display unit 1080 may display process schedule information about the selected components included in the design information of the nuclear power plant equipment and displays information about an input/output status and an installed status received from the construction status database 1130 to enable a manager to easily grasp a status of the selected component.

According to an aspect, the receiver 1060 may periodically receive information about an installation status of components having a class Q at a predetermined time interval from the construction status database 1130, and in this case, the class-based three-dimensional modeling apparatus for the nuclear power plant equipment may further include a transmitter 1040 for transmitting installation status information about any one component to the manager device in response to determination that a process of any one of components having a class Q has been performed based on information about an installation status.

A design information database 1110 and a quality class database 1130 may exist, and the modeling unit 1070 may select and output information from the database and the receiver 1060 according to an input (display request on a quality class basis) of the input unit 1050. The output may be display, alarm, output to user terminal, external output, etc.

A specific operation of an apparatus for quality class-based three-dimensional modeling of nuclear power plant equipment according to an embodiment of the present invention may follow a quality class-based three-dimensional modeling method of the above-described nuclear power plant equipment.

The above-described emotional analysis method and apparatus according to the present invention may be embodied as computer readable codes on a computer readable recording medium. The computer readable recording medium includes all kinds of record media that store data that may be read by a computer system. For example, the computer readable recording medium may include a read only memory (ROM), a random access memory (RAM), a magnetic tape, a magnetic disk, a flash memory, and an optical data storage device. Further, the computer readable recording medium may be distributed in a computer system connected to a computer communication network and stored and executed as a code that may be read in a distributed manner.

Although the present invention has been described with reference to the drawings and the embodiments, it is not intended that the scope of protection of the present invention is limited by the drawings or embodiments, and it will be understood by those skilled in the art that the present invention may be variously changed and modified without departing from the spirit and scope of the present invention described in the following claims.

1. A method of quality class-based three-dimensional modeling of nuclear power plant equipment, the method comprising:
receiving design information of the nuclear power plant equipment and information about a plurality of components constituting the nuclear power plant equipment from a design information database;
receiving information about a quality class of each of the plurality of components from a quality class database; and
three-dimensionally modeling and displaying at least some of a plurality of components constituting the nuclear power plant equipment according to the design information of the nuclear power plant equipment,
wherein the three-dimensional modeling and displaying comprises displaying information about a quality class corresponding to each of the plurality of components.

2. The method of claim 1, further comprising receiving an input of selection of at least one quality class from a user, before the three-dimensional modeling and displaying,
wherein the three-dimensional modeling and displaying comprises displaying only components having the selected quality class.

3. The method of claim 1, wherein the three-dimensional modeling and displaying comprises displaying components having different quality classes with different colors.

4. The method of claim 1, further comprising:
receiving an input of selection of a predetermined quality class from a user, after the three-dimensional modeling and displaying; and
highlighting a component having the selected quality class.

5. The method of claim 1, further comprising:
receiving an input of selection of one of the displayed components, after the three-dimensional modeling and displaying;
receiving information about an input/output status and an installation status of the selected component from a construction status database; and
displaying process schedule information about the selected component included in the design information of the nuclear power plant equipment and information about the input/output status and the installation status received from the construction status database.

6. The method of claim 1, wherein the quality class comprises a class Q (stability related item), a class A (stability impact item), and a class S (general industrial item).

7. The method of claim 6, further comprising:
receiving information about an installation status of components having a class Q at a predetermined time interval from the construction status database; and
transmitting installation status information about any one component to a manager device in response to determination that a process of any one of the components having a class Q has been performed based on the information about the installation status.

8. An apparatus for quality class-based three-dimensional modeling of nuclear power plant equipment, the apparatus comprising:
a receiver for receiving design information of the nuclear power plant equipment and information about a plurality of components constituting the nuclear power plant equipment from a design information database and information about a quality class of each of the plurality of components from a quality class database; and
a modeling unit for three-dimensional modeling at least some of a plurality of components constituting the nuclear power plant equipment according to the design information of the nuclear power plant equipment; and
a display unit for displaying at least some of the plurality of three-dimensionally modeled components,
wherein the display unit further displays information about a quality class corresponding to each of the plurality of components.

9. The apparatus of claim 8, further comprising an input unit for receiving an input of selection of one of the displayed components,
wherein the receiver further receives information about an input/output status and an installation status of the selected component from a construction status database, and
the display unit displays process schedule information about the selected component included in the design information of the nuclear power plant equipment and information about an input/output status and an installation status received from the construction status database.

10. The apparatus of claim 8, wherein the quality class comprises a class Q (stability related item), a class A (stability impact item), and a class S (general industrial item).

11. The apparatus of claim 10, wherein the receiver receives information about an installation status of components having a class Q at a predetermined time interval from the construction status database, and
the quality class-based three-dimensional modeling apparatus for the nuclear power plant equipment further includes a transmitter for transmitting installation status information of any one component to a manager device in response to determination that a process of any one of components having a class Q has been performed based on the information about the installation status.

12. A computer readable storage medium for storing instructions for quality class-based three-dimensional modeling of nuclear power plant equipment, the computer readable storage medium enables a processor of the computer to comprise:
an instruction for enabling to receive design information of nuclear power plant equipment and information about a plurality of components constituting the nuclear power plant equipment from a design information database;
an instruction for enabling to receive information about a quality class of each of the plurality of components from a quality class database; and
an instruction for enabling to three-dimensionally model and display at least some of a plurality of components constituting the nuclear power plant equipment according to design information of the nuclear power plant equipment,
wherein the instruction for enabling to three-dimensionally model and display is configured to further display information about a quality class corresponding to each of the plurality of components.
